(19) United States
(12) Patent Application Publication
(10) Pub. No.: US 2007/0253769 A1
(43) Pub. Date: Nov. 1, 2007

(54) FASTENING DEVICE FOR MOUNTING A THERMAL MODULE TO AN ELECTRONIC COMPONENT

(75) Inventors: CHING-BAI HWANG, TU CHENG (TW); JIE-BO PENG, SHENZHEN (CN); JIN-GONG MENG, SHENZHEN (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., TU CHENG (TW)

(21) Appl. No.: 11/308,729

(22) Filed: Apr. 26, 2006

(51) Int. Cl. B25G 3/18

(52) U.S. Cl. 403/326

(57) ABSTRACT

A fastening device (10) for mounting a first member (12) to a second member, the fastening device includes base member (14) and a resilient spring member (15). The base member includes a contacting plate (141) contacting with the second member, and a receiving channel for (147) receiving a portion of the first member therein. The resilient spring member includes two ends for being attached to a board with the second member mounted thereon, and a middle portion contacted with the first member to sandwich the first member between the second member and the spring member.

### FIELD OF THE INVENTION

The present invention relates generally to a fastening device, and more particularly to a fastening device for mounting a thermal module onto a heat generating electronic component.

### DESCRIPTION OF RELATED ART

A thermal module includes a die-casting member, a heat pipe, a fin assembly and a strip-like spring member. The die-casting member has a bottom surface contacting with a heat-generating electronic component mounted on a circuit board. The heat pipe includes an evaporator section received in a receiving channel of the die-casting member, and a condenser section contacted with the fin assembly. The spring member includes a middle portion contacting with an upper surface of the die-casting member, and two ends for being attached to the circuit board. When the ends of the spring member are attached to the circuit board, the middle portion of the spring member urges the die-casting member toward the circuit board to mount the thermal module thereon, whereby the die-casting member can have an intimate contact with an electronic component mounted on the circuit board.

In the thermal module, the die-casting member is formed by injecting molten metallic materials into a mold. Such way of producing the die-casting member complexes the manufacture of the thermal module and increases the weight of the thermal module. These factors in turn increase the cost of the thermal module and violate the need of lighter electric products. So a thermal module with lower cost and lighter weight is needed.

### SUMMARY OF INVENTION

The present invention relates to a fastening device for mounting a thermal module onto a heat generating electronic component. According to a preferred embodiment of the present invention, the fastening device includes a base member and a resilient spring member. The base member includes a contacting plate for contacting with the electronic component, and a receiving channel for receiving an evaporating portion of a heat pipe of the thermal module therein. The resilient spring member includes two ends for being attached to a board with the electronic component mounted thereon, and a middle portion contacted with the evaporating portion of the heat pipe to sandwich the evaporating portion of the heat pipe between the base member and the spring member.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is an assembled view of a thermal module according to a preferred embodiment of the present invention;

FIG. 2 is an exploded, isometric view of the thermal module of FIG. 1;

FIG. 3 is a top view of a blank plate which is to be stamped to form a base member of the thermal module of FIG. 1;

FIG. 4 is an assembled view of a thermal module according to a second embodiment of the present invention;

FIG. 5 is an isometric view of a base member of the thermal module of FIG. 4; and

FIG. 6 is a top view of a blank plate which is to be stamped to form the base member of FIG. 5.

### DETAILED DESCRIPTION

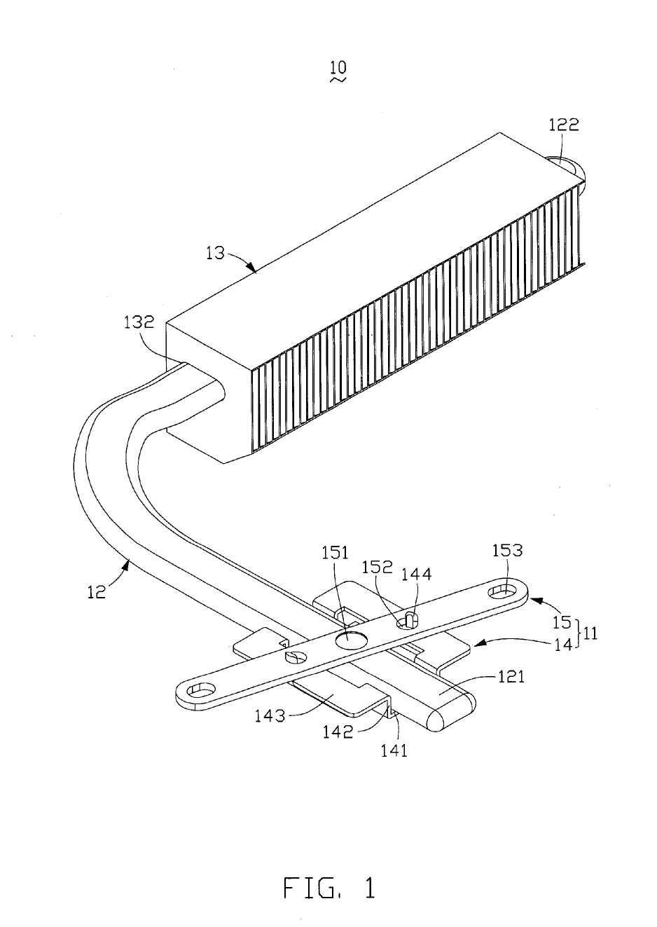

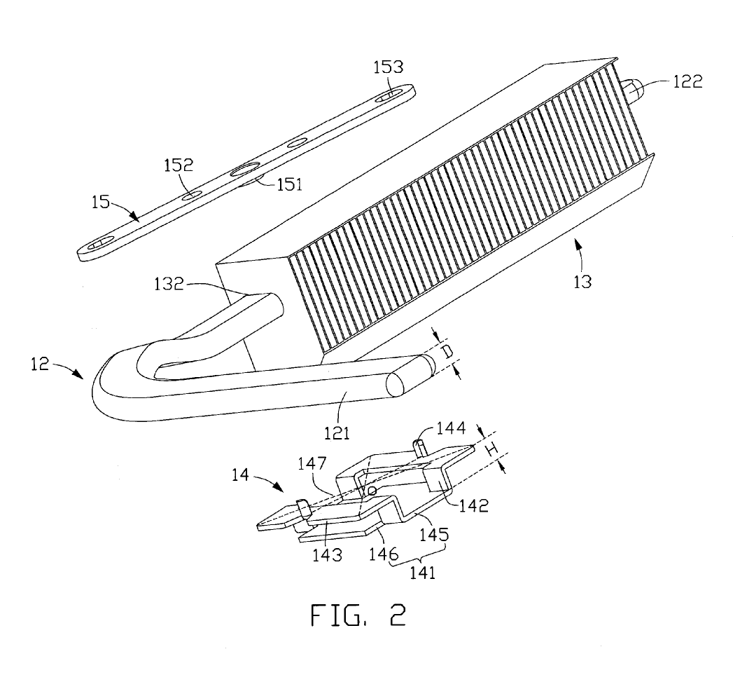

Referring to FIGS. 1 and 2, a thermal module 10 according to a preferred embodiment of the present invention is shown. The thermal module 10 includes a fastening device 11, a heat pipe 12, and a fin assembly 13. The fastening device 11 includes a base member 14 for contacting with a heat-generating electronic component (not shown) mounted on a circuit board (not shown), and a strip-like spring member 15 for mounting the fastening device 11 to the circuit board (not shown) whereby the base member 14 can have an intimate contact with the heat-generating component. The heat pipe 12 includes a flattened evaporator section 121 received in and contacted with the base member 14 for absorbing heat from the heat generating electronic component, and a condenser section 122 soldered in the fin assembly 13 for transferring the heat to the fin assembly 13. The evaporator section 121 of the heat pipe 12 is received in the base member 14 of the fastening device 11, while the condenser section 122 of the heat pipe 12 extends through a through hole 132 of the fin assembly 13.

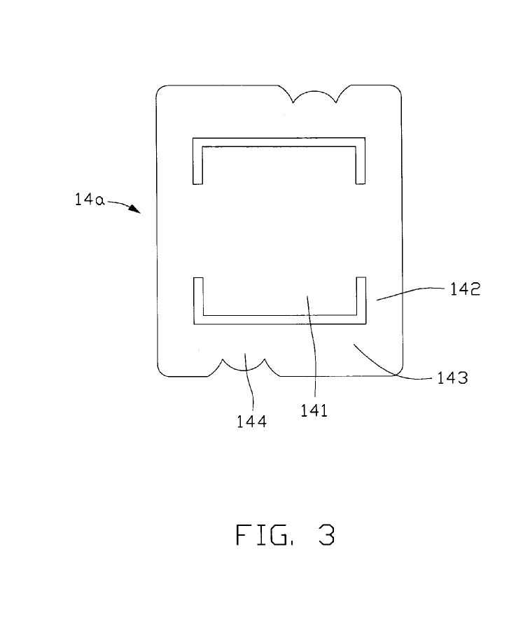

The base member 14 is formed by stamping a blank plate 14a, shown in FIG. 3. The base member 14 includes a planar contacting plate 141, four sidewalls 142 perpendicularly bending upwardly from the contacting plate 141, two wings 143 horizontally bending outwardly from the sidewalls 142, and two locating pins 144 perpendicularly formed upwardly from the wings 143. The contacting plate 141 has a cross-shaped configuration, and includes a first plate 145 and a second plate 146 intercrossed with the first plate 145. The sidewalls 142 extend from ends of two sides of the first plate 145, with two sidewalls 142 at the same side of the first plate 145 spaced from each other. Ends of the second plate 146 extend outwardly beyond the adjacent sidewalls 142 for increasing thermal contacting areas between the heat generating component and the contacting plate 141. A receiving channel 147 is formed between the contacting plate 141 and the sidewalls 142 for receiving the evaporator section 121 of the heat pipe 12 therein. A depth H of the receiving channel 147 is greater than a thickness D of the evaporator section 121 of the heat pipe 12. A layer of thermal grease (not shown) is spread on the sidewalls 142 and a top face of the first plate 145 for improving heat conductivity between the evaporator section 121 of the heat pipe 12 and the base member 14. The locating pins 144 are formed centrosymmetric to each other in respect to a central point O of the base member 14.

The spring member 15 is made of resilient materials, such as steel, copper, or aluminum. The spring member 15 includes a bulge 151 stamped downwardly from a middle portion thereof, two locating holes 152 symmetrically defined at two sides of the bulge 151, and two pierces 153 defined adjacent to two ends of the spring member 15. As the spring member 15 is mounted to the base member 14, the bulge 151 abuts against an upper surface of the evaporator section 121 of the heat pipe 12, and urges the evaporator section 121 of the heat pipe 12 to move downwardly to intimately contact with the contacting plate 141 of the base member 14. Alternatively, the bulge 151 of the spring member 15 may be canceled, if the thickness D of the evaporator section 121 of the heat pipe 12 is a bit greater than the depth H of the receiving channel 147. Under this condition, a bottom surface of the middle portion of the spring member 15 abuts against the upper surface of the evaporator section 121 of the heat pipe 12, and urges the evaporator section 121 of the heat pipe 12 to intimately contact with the contacting plate 141 of the base member 14.

In assembly of the thermal module 10, the thermal grease is spread in the receiving channel 147 of the base member 14. The evaporator section 121 of the heat pipe 12 is disposed in the receiving channel 147 of the base member 14. The spring member 15 is mounted onto the wings 143 of the base member 14, with the locating pins 144 of the base member 14 extending through the locating holes 152 of the spring member 15. The locating pins 144 are flattened downwardly to abut against an upper surface of the spring member 15. Meanwhile, the bulge 151 of the spring member 15 aligns with the central point O of the base member 14 and intimately abuts against the upper surface of the evaporator section 121 of the heat pipe 12. The bulge 151 of the spring member 15 urges the evaporator section 121 of the heat pipe 12 to move downwardly to intimately contact with the contacting plate 141 of the base member 14. Thus, the evaporator section 121 of the heat pipe 12 is intimately sandwiched between the spring member 15 and the base member 14, and the heat pipe 12 is preassembled to the fastening device 11. Finally, a plurality of fixing members (not shown) such as screws extends through the pierces 153 of the spring member 15 and the circuit board to securely connect with a back plate at a bottom of the circuit board, thereby urging the spring member 15 to distort downwardly toward the circuit board, and thereby fixing the thermal module 10 onto the circuit board with the contacting plate 141 of the base member 14 intimately contacting with the heat-generating component.

In the present invention, the base member 14 of the fastening device 11 is formed by stamping the blank plate 14a. The blank plate 14a is lighter than the die-casting member of the related art. Thus, the weight of the thermal module 10 is decreased. Furthermore, such way of manufacturing the base member 14 simplifies the produce of the thermal module 10, thereby reducing the cost of the thermal module 10. In addition, the locating pins 144 are centrosymmetric to each other in respect to the central point O of the base member 14. This makes the force of the spring member 15 exerted on the evaporator section 121 of the heat pipe 12 be evenly distributed around the central point O of the base member 14. The force is transferred to a central area of a contacting surface between the contacting plate 141 of the base member 14 and the heat-generating electronic component. This prevents a middle portion of the contacting plate 141 of the base member 14 from distorting upwardly in case the force is exerted on sides of the contacting plate 141, which hinders heat conductivity between the base member 14 of the thermal module 10 and the heat-generating electronic component.

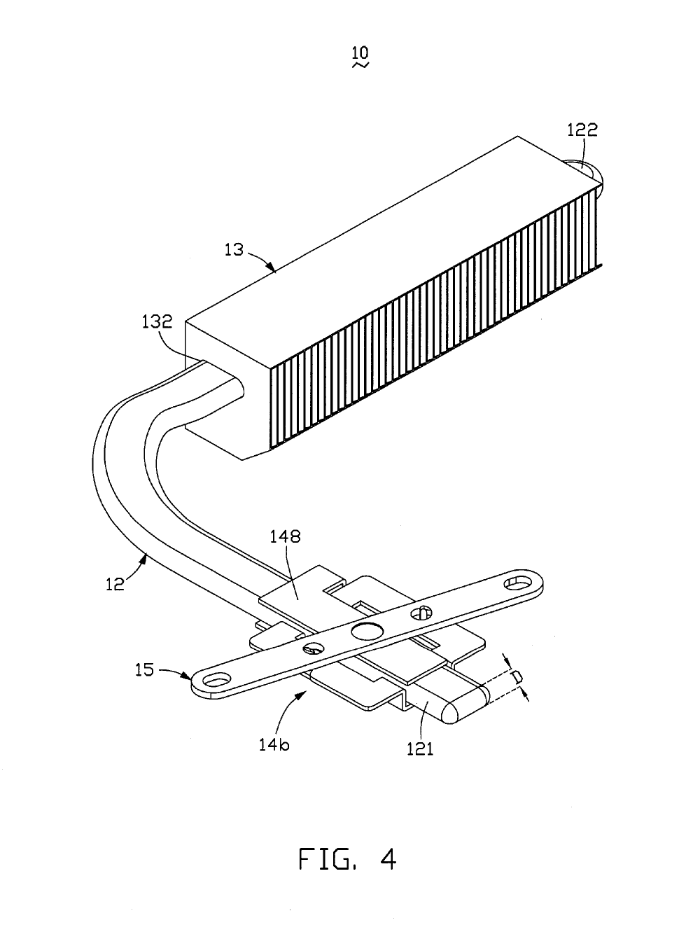

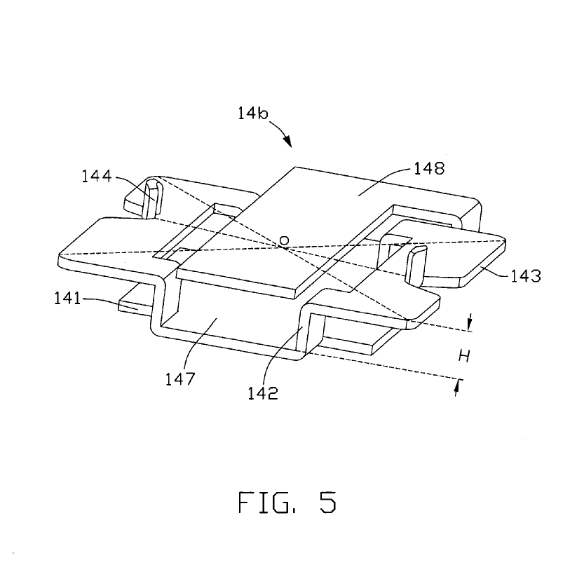

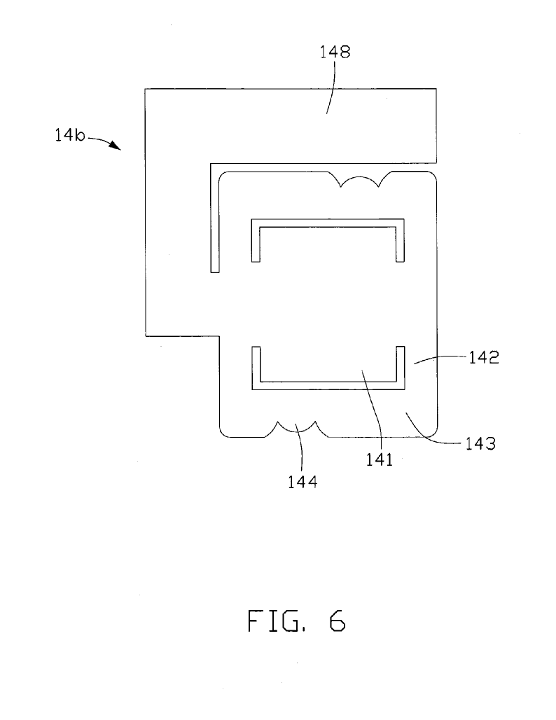

FIGS. 4 to 6 show a second embodiment of the present invention. The difference between this embodiment and the first embodiment is: the base member 14b extends a covering plate 148 upwardly from the contacting plate 141. When the spring member 15 is attached to the base member 14, the covering plate 148 is sandwiched between the evaporator section 121 of the heat pipe 12 and the middle portion of the spring member 15. The covering plate 148 contacts with the upper surface of the evaporator section 121 of the heat pipe 12, and disperses the force exerted by the bulge 151 of the spring member 15 over a larger area, thereby preventing the heat pipe 12 from being damaged by a concentrated force at the bulge 151. Moreover, the covering plate 148 increases contacting areas between the evaporator section 121 of the heat pipe 12 and the base member 14, thereby improving heat transfer therebetween. The heat dissipation efficiency of the thermal module 10 is further improved.

In the present invention, the locating pins 144 and the locating holes 152 are respectively formed on the base member 14 and the spring member 15. Alternatively, the locating pins 144 may extend from the spring member 15, while the locating holes 152 may accordingly be defined in the base member 14.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastening device configured for mounting a first member to a second member, the fastening device comprising:
a base member comprising a contacting plate for contacting with the second member, and a receiving channel for receiving a portion of the first member therein; and
a resilient spring member comprising two ends adapted for being attached to a board with the second member mounted thereon, and a middle portion for contacting with the first member to sandwich the first member between the second member and the spring member.

2. The fastening device as described in claim 1, wherein the second member is a heat-generating electronic component, the first member is a heat pipe.

3. The fastening device as described in claim 1, wherein the base member is formed by stamping a metal sheet.

4. The fastening device as described in claim 1, wherein one of the spring member and the base member defines at least two locating holes therein, and the other one of the spring member and the base member projects two locating pins therefrom, the locating pins extend through the locating holes respectively for locating the spring member to the base member to sandwich the first member therebetween.

5. The fastening device as described in claim 4, wherein the base member comprises four sidewalls extending upwardly from the contacting plate, the receiving channel is formed between the contacting plate and the sidewalls.

6. The fastening device as described in claim 5, wherein the base member extends a covering plate from the contacting plate to cover on the first member.

7. The fastening device as described in claim 5, wherein the base member comprises two wings extending outwardly from the sidewalls, the locating pins are extended from the wings.

8. The fastening device as described in claim 7, wherein the locating pins are arranged centrosymmetric to each other in respect to a central point of the base member.

9. The fastening device as described in claim 5, wherein the contacting plate has a cross-shaped configuration, and includes a first plate and a second plate intercrossed with the first plate, the sidewalls extend upwardly from ends of two sides of the first plate with two sidewalls at the same side of the first plate spaced from each other.

10. The fastening device as described in claim 9, wherein ends of the second plate extend outwardly beyond adjacent sidewalls for increasing thermal contacting areas between the second member and the contacting plate.

11. The fastening device as described in claim 1, wherein the spring member comprises two pierces at the ends thereof for extending two fixing member therethrough to mount the spring member onto the board.

12. A thermal module comprising:
a fin assembly;
a heat pipe comprising an evaporator section adapted for thermally connecting with a heat-generating component mounted on a circuit board, and a condenser section connected with the fin assembly; and
a fastening device for mounting the evaporator section of the heat pipe to the heat-generating component, comprising:
a stamped base member receiving the evaporator section of the heat pipe therein and adapted for contacting with the heat-generating component; and
a spring member mounted to the base member to sandwich the evaporator section of the heat pipe therebetween, the spring member comprising two ends adapted to be attached to the circuit board to mount the thermal module thereon.

13. The thermal module as described in claim 12, wherein the evaporator section of the heat pipe is sandwiched between a middle portion of the spring member and the base member, the middle portion of the spring member extends a bulge therefrom for abutting against an upper surface of the evaporator section of the heat pipe.

14. The thermal module as described in claim 12, wherein one of the spring member and the base member defines at least two locating holes therein, and the other one of the spring member and the base member projects two locating pins therefrom, the locating pins extend through the locating holes respectively for mounting the spring member to the base member.

15. The thermal module as described in claim 14, wherein the base member comprises a contacting plate contacted with the heat-generating component, at least two sidewalls extending upwardly from the contacting plate, and two wings outwardly from the sidewalls, the locating pins are arranged on the wings and centrosymmetric to each other in respect to a central point of the base member which aligns with the bulge of the spring member.

16. The thermal module as described in claim 15, wherein a receiving channel is formed between the contacting plate and the sidewalls for receiving the evaporator section of the heat pipe therein.

17. A thermal module comprising:
a fin assembly;
a base member formed by bending a metal plate, having a bottom contacting plate adapted for contacting with a heat generating electronic component, a channel above the contacting plate and at least two upwardly projecting locating pins;
a heat pipe having a condensing section thermally connecting with the fin assembly and an evaporating section received in the channel and thermally connecting with the contacting plate; and
a spring plate mounted on the base member, pressing the evaporating section of the heat pipe against the contacting plate and securely engaging with the at least two locating pins.

18. The thermal module as described in claim 17, wherein the spring plate has a downward bulge abutting against the evaporating section of the heat pipe, the bulge being located in alignment with a center of the base member.

19. The thermal module as described in claim 18, wherein the at least pins are centrosystemeric to each other in respect to the center of the base member.

20. The thermal module as described in claim 18, wherein the base member further comprises a cover plate sandwiched between the spring plate and the evaporating section of the heat pipe.
